(19) United States
(12) Patent Application Publication
(10) Pub. No.: US 2024/0429548 A1
(43) Pub. Date: Dec. 26, 2024

(54) BATTERY PACK

(71) Applicant: Prime Planet Energy & Solutions, Inc., Tokyo (JP)

(72) Inventor: Takuya EGASHIRA, Himeji-shi (JP)

(21) Appl. No.: 18/732,629

(22) Filed: Jun. 4, 2024

(30) Foreign Application Priority Data
Jun. 26, 2023 (JP) 2023-104398

(51) Int. Cl. H01M 50/358; H01M 50/209; H01M 50/271; H01M 50/342

(52) U.S. Cl. CPC H01M 50/358; H01M 50/209; H01M 50/271; H01M 50/3425

(57) ABSTRACT

A battery pack includes: a case main body provided with an opening; and a cover that is attached to the case main body so as to close the opening and that forms, together with the case main body, a space for accommodating a plurality of battery cells. Each of the battery cells has: an exterior package that includes a top surface facing the cover; and a gas-release valve that releases gas from inside of the exterior package to the space through the top surface. The battery pack further includes a plate member that has a main portion and a fixation portion, the main portion being disposed between the top surface and the cover in the space, the fixation portion extending from the main portion, the fixation portion being fixed, the main portion being provided with a plurality of through holes, the plate member being composed of a metal or ceramic.

### CROSS REFERENCE TO RELATED APPLICATIONS

This nonprovisional application is based on Japanese Patent Application No. 2023-104398 filed on Jun. 26, 2023 with the Japan Patent Office, the entire contents of which are hereby incorporated by reference.

### BACKGROUND OF THE INVENTION

### Field of the Invention

The present invention relates to a battery pack.

### Description of the Background Art

For example, WO 2020/189590 discloses a battery pack including: a secondary battery; a housing that accommodates the secondary battery; and a plate-shaped reinforcing portion that extends from one end to the other end of the housing in a long-side direction thereof and that is disposed in a height direction of the secondary battery so as to reinforce the housing.

### SUMMARY OF THE INVENTION

In the above-described battery pack disclosed in WO 2020/189590, the housing (case) that accommodates the secondary battery is constituted of: a main body portion having a rectangular box shape, the main body portion being opened at its upper portion; and a cover that covers the opening of the main body portion.

In such a battery pack, there is such a concern that when high-pressure gas is released from a battery cell into the case in response to occurrence of a battery abnormality, the gas released from the battery cell hits the cover to damage the cover. Further, the plate-shaped reinforcing portion disposed in the height direction of the secondary battery can function as a baffle plate that prevents gas from directly hitting the cover; however, there is such a concern that an excessive load is applied to a fixation portion of the reinforcing portion due to the high-pressure gas being received.

Therefore, it is an object of the present invention to solve the above-described problem and to provide a battery pack that is appropriately protected when gas is generated in a battery cell.

[1] A battery pack comprising: a plurality of battery cells; a case main body provided with an opening; and a cover that is attached to the case main body so as to close the opening and that forms, together with the case main body, a space for accommodating the plurality of battery cells, wherein each of the battery cells has an exterior package that includes a top surface facing the cover and that accommodates an electrode assembly and an electrolyte solution, and a gas-release valve that releases gas from inside of the exterior package to the space through the top surface when pressure in the exterior package becomes equal to or more than a predetermined value, the battery pack further comprising a plate member that has a main portion and a fixation portion, the main portion being disposed between the top surface and the cover in the space, the fixation portion extending from the main portion, the fixation portion being fixed, the main portion being provided with a plurality of through holes, the plate member being composed of a metal or ceramic.

According to the battery pack thus configured, since the gas released from the gas-release valve is received by the main portion, the gas can be suppressed from directly hitting the cover, thereby preventing damage of the cover. In this case, since the plurality of through holes are provided in the main portion, pressure received by the plate member from the gas can be reduced, thereby preventing application of an excessive load to the fixation portion. Therefore, the battery pack can be appropriately protected when gas is generated in the battery cell.

[2] The battery pack according to [1], further comprising a duct that forms a gas flow path communicating with the space and that discharges the gas from the space.

According to the battery pack thus configured, since the plurality of through holes are formed in the main portion, a rate (gas filling rate) of filling the space with the gas is reduced. Thus, it is possible to sufficiently secure a time to discharge the gas from the space through the duct, thereby suppressing an increased internal pressure of the space.

[3] The battery pack according to [1] or [2], wherein each of the plurality of through holes is provided at a position not facing the gas-release valve.

According to the battery pack thus configured, the gas released from the gas-release valve can be more effectively suppressed from directly hitting the cover.

[4] The battery pack according to any one of [1] to [3], wherein the plate member further has a deformation portion provided between the main portion and the fixation portion, the deformation portion being elastically deformable.

According to the battery pack thus configured, when the gas released from the gas-release valve is received by the main portion, the deformation portion is elastically deformed, thereby more securely preventing application of an excessive load to the fixation portion.

[5] The battery pack according to any one of [1] to [4], further comprising a connector attached to the case main body, wherein the plate member further has a shielding portion that extends from the main portion and that shields between the connector and each of the battery cells.

According to the battery pack thus configured, by the shielding portion, the high-temperature gas can be suppressed from flowing toward the connector. Thus, a thermal load on the connector can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery pack according to an embodiment of the present invention.

FIG. 2 is an exploded assembly diagram showing the battery pack in FIG. 1.

FIG. 3 is a perspective view showing a battery cell.

FIG. 4 is a cross sectional view schematically showing the battery pack when viewed in a direction of arrow along a line IV-IV in FIG. 1.

FIG. 5 is a graph showing a change in an amount of gas in a space when the gas is generated in a battery cell.

FIG. 6 is a cross sectional view showing a first modification of the battery pack in FIG. 4.

FIG. 7 is a cross sectional view showing a second modification of the battery pack in FIG. 4.

FIG. 8 is a perspective view showing a modification of the plate member in FIG. 7.

FIG. 9 is a cross sectional view showing a third modification of the battery pack in FIG. 4.

FIG. 10 is a perspective view showing the plate member in FIG. 9.

FIG. 11 is a cross sectional view showing a modification of the battery pack in FIG. 9.

FIG. 12 is a perspective view showing the plate member in FIG. 11.

### DESCRIPTION OF THE PREFERRED EMBODIMENTS

Embodiments of the present invention will be described with reference to figures. It should be noted that in the figures referred to below, the same or corresponding members are denoted by the same reference characters.

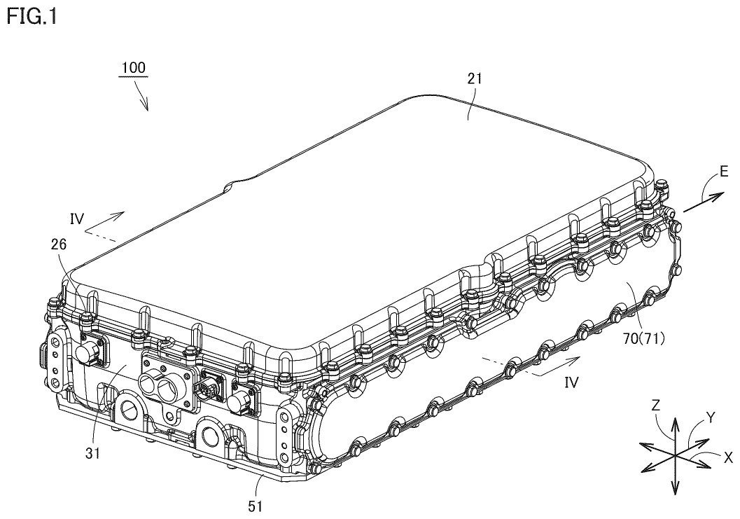

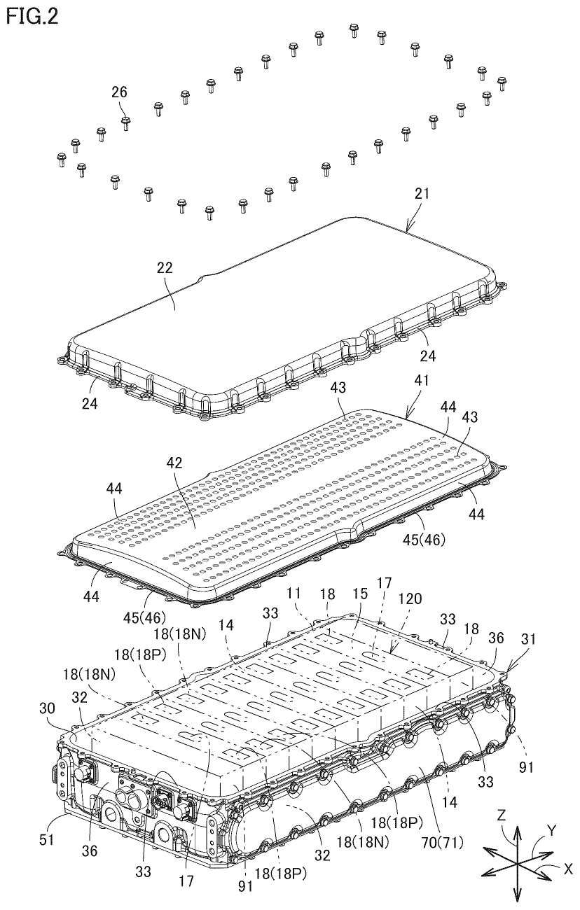

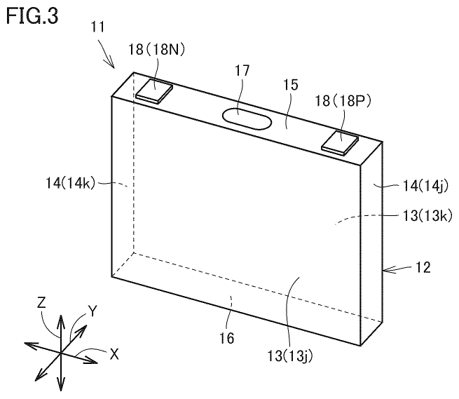

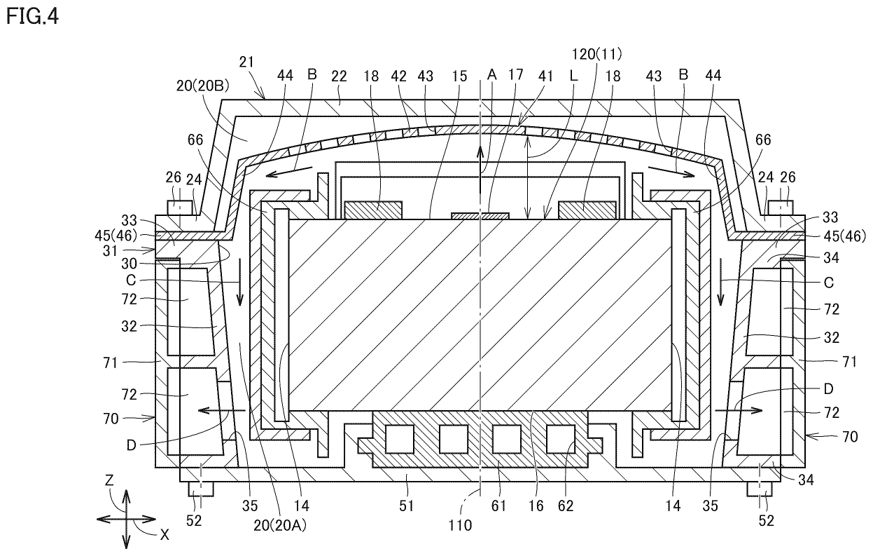

FIG. 1 is a perspective view showing a battery pack according to an embodiment of the present invention. FIG. 2 is an exploded assembly diagram showing the battery pack in FIG. 1. FIG. 3 is a perspective view showing a battery cell. FIG. 4 is a cross sectional view schematically showing the battery pack when viewed in a direction of arrow along a line IV-IV in FIG. 1.

Referring to FIGS. 1 to 4, a battery pack 100 is used as a power supply for driving a vehicle such as a hybrid electric vehicle (HEV), a plug-in hybrid electric vehicle (PHEV), or a battery electric vehicle (BEV).

In the present specification, for convenience of explanation of a structure of battery pack 100, a “Y axis” represents an axis extending in a stacking direction of a plurality of below-described battery cells 11 and in a horizontal direction, an “X axis” represents an axis extending in a direction orthogonal to the Y axis and in the horizontal direction, and a “Z axis” represents an axis extending in an upward/downward direction. As shown in FIG. 4, battery pack 100 basically has a structure symmetrical with respect to an imaginary plane 110 parallel to the Y-Z axes plane.

Battery pack 100 has a plurality of battery cells 11. The plurality of battery cells 11 are stacked in the Y axis direction. Each of battery cells 11 is constituted of a lithium ion battery. Battery cell 11 has a prismatic shape and has a thin plate shape in the form of a rectangular parallelepiped. The plurality of battery cells 11 are stacked such that the Y axis direction corresponds to the thickness direction of each battery cell 11.

Each of battery cells 11 has an exterior package 12. Exterior package 12 is constituted of a housing having a rectangular parallelepiped shape, and forms an external appearance of battery cell 11. An electrode assembly and an electrolyte solution are accommodated in exterior package 12.

Exterior package 12 has a pair of first side surfaces 14 (14j, 14k), a pair of second side surfaces 13 (13j, 13k), a top surface 15, and a bottom surface 16.

First side surfaces 14 are each constituted of a flat surface orthogonal to the X axis. First side surfaces 14 are each parallel to the Y axis direction, which is the stacking direction of battery cells 11. First side surface 14j and first side surface 14k are oriented oppositely in the X axis direction. Second side surfaces 13 are each constituted of a flat surface orthogonal to the Y axis. Each of second side surfaces 13 has the largest area among those of the plurality of side surfaces of exterior package 12. Second side surface 13j and second side surface 13k are oriented oppositely in the Y axis direction. Each of top surface 15 and bottom surface 16 is constituted of a flat surface orthogonal to the Z axis. Top surface 15 is oriented upward. Top surface 15 faces a below-described cover 21. Bottom surface 16 is oriented downward.

Battery cell 11 further has a gas-release valve 17. Gas-release valve 17 is provided in top surface 15. Gas-release valve 17 is provided at the central position of top surface 15 in the X axis direction. When pressure in exterior package 12 becomes equal to or more than a predetermined value, gas-release valve 17 releases the gas from inside of exterior package 12 to outside (space 20 described later) of exterior package 12 through top surface 15.

Battery cell 11 further has electrode terminals 18 including a pair of a positive electrode terminal 18P and a negative electrode terminal 18N. Each of electrode terminals 18 is provided on top surface 15. Positive electrode terminal 18P and negative electrode terminal 18N are provided to be separated from each other in the X axis direction. Positive electrode terminal 18P and negative electrode terminal 18N are provided on both sides beside gas-release valve 17 in the X axis direction.

The plurality of battery cells 11 are stacked such that second side surfaces 13j of battery cells 11, 11 adjacent to each other in the Y axis direction face each other and second side surfaces 13k of battery cells 11, 11 adjacent to each other in the Y axis direction face each other. Thus, positive electrode terminals 18P and negative electrode terminals 18N are alternately arranged in the Y axis direction in which the plurality of battery cells 11 are stacked. Between battery cells 11, 11 adjacent to each other in the Y axis direction, positive electrode terminal 18P and negative electrode terminal 18N arranged side by side in the Y axis direction are connected to each other by a bus bar (not shown). The plurality of battery cells 11 are electrically connected to one another in series.

It should be noted that each of the battery cells of the present invention is not limited to having a prismatic shape and may have a cylindrical shape. For example, the plurality of battery cells are arranged at intervals in the X-Y axes plane with each of the battery cells being in an upright posture in which the cylindrical axis of the battery cell extends in the Z axis direction. In this case, the gas-release valve may be provided inside a sealing body included in the top surface of the battery cell.

As shown in FIG. 2, the plurality of battery cells 11 stacked in the Y axis direction form a cell stack 120. Cell stack 120 has a rectangular parallelepiped shape. The length of cell stack 120 in the Y axis direction is larger than the length of cell stack 120 in the Z axis direction and is larger than the length of cell stack 120 in the X axis direction. Cell stack 120 has a rectangular shape in which the Y axis direction corresponds to its long-side direction and the X axis direction orthogonal to the Y axis direction corresponds to its short-side direction when viewed in a plan view in the Z axis direction. It should be noted that the number of rows in cell stack 120 disposed in battery pack 100 is not limited to one and two or more rows may be arranged therein.

Battery pack 100 further has a pair of end plates 91 and a pair of binding bars 66 (not shown in FIG. 2 and see FIG. 4). The pair of end plates 91 are respectively disposed at both ends of cell stack 120 (the plurality of battery cells 11) in the Y axis direction. The pair of binding bars 66 are disposed at both ends of cell stack 120 in the X axis direction. Each of binding bars 66 extends in the Y axis direction and is connected to the pair of end plates 91 at both ends thereof. The plurality of battery cells 11 are collectively held by the pair of end plates 91 and the pair of binding bars 66.

Battery pack 100 further has a case main body 31 and a cover 21. Each of case main body 31 and cover 21 is composed of a metal. Each of case main body 31 and cover 21 is composed of aluminum, for example. Case main body 31 is provided with an opening 30. Opening 30 is opened upward. Cover 21 is attached to case main body 31 so as to close opening 30. Cover 21 forms, together with case main body 31, a space 20 for accommodating the plurality of battery cells 11.

Case main body 31 has a bottom portion 51, a pair of first side portions 32, and a pair of second side portions 36. Bottom portion 51 has a wall shape in which bottom portion 51 is disposed along the X-Y axes plane with the Z axis direction corresponding to its thickness direction. Bottom portion 51 has a rectangular shape when viewed in a plan view in the Z axis direction. Cell stack 120 is placed on bottom portion 51. A cooling plate 61 is interposed between bottom portion 51 and cell stack 120. Cooling plate 61 is provided with a coolant path 62 extending in the Y axis direction.

The pair of first side portions 32 and the pair of second side portions 36 rise from the peripheral edge of bottom portion 51. The pair of first side portions 32 face each other in the X axis direction with space 20 being interposed therebetween. Each of first side portions 32 has a wall shape in which first side portion 32 is disposed along the Y-Z axes plane with the X axis direction corresponding to its thickness direction. The pair of second side portions 36 face each other in the Y axis direction with space 20 being interposed therebetween. Each of second side portions 36 has a wall shape in which second side portion 36 is disposed along the X-Z axes plane with the Y axis direction corresponding to its thickness direction.

Bottom portion 51 is fastened to the pair of first side portions 32 and the pair of second side portions 36 using a plurality of bolts 52. It is not limited to such a configuration, and bottom portion 51, the pair of first side portions 32, and the pair of second side portions 36 may be integrally formed from a metal.

Space 20 is formed at a position located above bottom portion 51 and surrounded by the pair of first side portions 32 and the pair of second side portions 36. Opening 30 is defined by the upper end portions of the pair of first side portions 32 and the pair of second side portions 36. Space 20 is opened to a space outside case main body 31 through opening 30.

Case main body 31 further has a first flange portion 33. First flange portion 33 extends in the form of a flange from the upper end portions of the pair of first side portions 32 and the pair of second side portions 36 in plane directions of the X-Y axes plane. First flange portion 33 is provided in the form of a frame along the upper end portions of the pair of first side portions 32 and the pair of second side portions 36.

Cover 21 has a cover main body portion 22 and a second flange portion 24. Cover main body portion 22 constitutes a main portion of cover 21, and closes opening 30. Cover main body portion 22 has a receiving pan shape so as to be opened downward with the Z axis direction corresponding to its depth direction. Second flange portion 24 extends in the form of a flange from the lower end portion of cover main body portion 22 in the plane directions of the X-Y axes plane. Second flange portion 24 is provided in the form of a frame along the lower end portion of cover main body portion 22. Second flange portion 24 overlaps with first flange portion 33 in the Z axis direction. Cover 21 is attached to case main body 31 by fastening first flange portion 33 and second flange portion 24 to each other using a plurality of bolts 26.

Battery pack 100 further has a plate member 41. Plate member 41 is composed of a material having heat resistance to such an extent that the material is not deformed even when exposed to high-temperature gas or flame generated from battery cell 11, and is preferably composed of a metal or ceramic. For example, plate member 41 is composed of a metal such as carbon steel, stainless steel, copper, aluminum, or titanium, or is composed of a ceramic such as alumina, zirconia, or silica. Plate member 41 may be formed by coating a surface of each of the materials with a resin material. The thickness of plate member 41 is smaller than the thickness of cover 21.

Plate member 41 has a main portion 42. Main portion 42 is provided in space 20. Main portion 42 is disposed between top surface 15 of each battery cell 11 and cover 21 in space 20. Main portion 42 faces top surfaces 15 in the Z axis direction. Main portion 42 faces gas-release valves 17 in the Z axis direction. Main portion 42 faces electrode terminals 18 (positive electrode terminals 18P and negative electrode terminals 18N) in the Z axis direction. Main portion 42 is provided above cell stack 120 (battery cells 11).

The length of main portion 42 in the X axis direction is larger than the length of cell stack 120 (battery cells 11) in the X axis direction. The length of main portion 42 in the Y axis direction is larger than the length of cell stack 120 in the Y axis direction. When viewed in a plan view in the Z axis direction, main portion 42 has a rectangular shape in which the Y axis direction corresponds to its long-side direction and the X axis direction corresponds to its short-side direction. The range of cell stack 120 when viewed in a plan view in the Z axis direction is included in the range of main portion 42 when viewed in a plan view in the Z axis direction.

A distance L between top surface 15 and main portion 42 in the Z axis direction is decreased in a direction away from gas-release valve 17 in the X axis direction. Distance L between top surface 15 and main portion 42 in the Z axis direction is maximum at a position on imaginary plane 110, and is decreased in a direction away from imaginary plane 110 in the X axis direction. Distance L between top surface 15 and main portion 42 in the Z axis direction is unchanged regardless of a position in the Y axis direction. Main portion 42 is inclined with respect to each of the X axis direction and the Z axis direction.

In the cross sectional view of battery pack 100 taken along the X-Z axes plane in FIG. 4, main portion 42 has a cross section with a curved shape. Main portion 42 may have a cross section with a shape of arc having an unchanged curvature. Main portion 42 may have a cross section with a shape of straight line.

Plate member 41 further has a guide portion 44 and a fixation portion 45. Guide portion 44 extends from the peripheral edge of main portion 42 in a direction toward bottom portion 51 in the Z axis direction. In the cross sectional view of battery pack 100 taken along the X-Z axes plane in FIG. 4, guide portion 44 extends from the peripheral edge of main portion 42 toward a duct 70 described later. Guide portion 44 forms, together with main portion 42, a receiving pan shape so as to be opened downward with the Z axis direction corresponding to its depth direction.

Fixation portion 45 extends from main portion 42. Fixation portion 45 is provided along the peripheral edge of guide portion 44 when viewed in a plan view in the Z axis direction. Fixation portion 45 extends in the form of a flange from the lower end portion of guide portion 44 in the plane directions of the X-Y axes plane. Fixation portion 45 is provided in the form of a frame along the lower end portion of guide portion 44.

Fixation portion 45 is fixed. Fixation portion 45 is a fixation portion (connection portion) of plate member 41 for supporting main portion 42 in space 20. Fixation portion 45 is sandwiched by case main body 31 and cover 21. Fixation portion 45 is interposed between first flange portion 33 and second flange portion 24. Fixation portion 45 receives fastening force by the plurality of bolts 26 between first flange portion 33 and second flange portion 24.

In the present embodiment, fixation portion 45 corresponds to a gasket 46 for sealing between case main body 31 and cover 21. That is, main portion 42 and gasket 46 are integrally formed from a plate material composed of a metal or ceramic. With such a configuration, the number of components of battery pack 100 can be reduced or the number of steps of assembling battery pack 100 can be reduced.

Space 20 is partitioned into a space 20A and a space 20B by plate member 41. Space 20B is surrounded by plate member 41 and cover 21. Space 20A is surrounded by plate member 41 and case main body 31. The plurality of battery cells 11 are accommodated in space 20A.

Main portion 42 is provided with a plurality of through holes 43. Through holes 43 each extend through main portion 42. The plurality of through holes 43 are provided at intervals. The plurality of through holes 43 are provided at intervals in each of the Y axis direction and the X axis direction when viewed in the Z axis direction. The plurality of through holes 43 are provided at positions not facing gas-release valves 17 in the Z axis direction. Space 20A and space 20B communicate with each other through the plurality of through holes 43.

Battery pack 100 further has duct 70. Duct 70 is provided to face first side surface 14 of battery cell 11. Duct 70 forms a gas flow path 72. Gas flow path 72 communicates with space 20. Duct 70 discharges, from space 20, gas released from gas-release valve 17.

Case main body 31 further includes a rib portion 34. Rib portion 34 protrudes from first side portion 32 in the X axis direction, and extends in the form of a rib along the peripheral edge of first side portion 32. Duct 70 has a pair of duct covers 71. The pair of duct covers 71 are attached to the pair of first side portions 32, respectively. Each of duct covers 71 is attached to first side portion 32 so as to come into abutment with rib portion 34 in the X axis direction.

Duct cover 71 forms a gas flow path 72 together with first side portion 32. A gas flow hole 35 is provided in first side portion 32. Gas flow hole 35 is constituted of a hole extending through first side portion 32, and communicates space 20 (20A) with gas flow path 72. Gas flow path 72 extends in the Y axis direction and is opened at one end portion thereof.

It is assumed that combustible gas is generated inside exterior package 12 in response to occurrence of a battery abnormality such as an internal short circuit in battery cell 11. The gas is discharged into space 20 (20A) through top surface 15 provided with gas-release valve 17 (gas flow indicated by an arrow A in FIG. 4). The gas hits plate member 41, is guided by main portion 42 to flow from the central portion of space 20 (20A) toward both end portions thereof in the X axis direction, and is further guided by guide portion 44 to flow downward through a clearance between cell stack 120 and each first side portion 32 (gas flow indicated by each of arrows B and C in FIG. 4). The gas is discharged from space 20 (20A) to gas flow path 72 through gas flow hole 35 (gas flow indicated by an arrow D in FIG. 4). The gas flows through gas flow path 72 in the Y axis direction and is discharged to the outside of duct 70 (gas flow indicated by an arrow E in FIG. 1).

In response to an increase in capacity of the battery in recent years, an amount of gas generated in battery cell 11 is increased. For this reason, high-pressure gas may be jetted from battery cell 11, or the gas may be increased in pressure to have a high temperature to result in spontaneous ignition. In preparation for such a case, plate member 41 is provided in battery pack 100 according to the present embodiment.

In space 20, main portion 42 disposed between each of top surfaces 15 of the plurality of battery cells 11 and cover 21 receives the high-pressure gas jetted from battery cell 11 or a shock wave caused by the spontaneous ignition, thereby preventing cover 21 from being damaged. In addition, main portion 42 also has a heat shielding function to prevent cover 21 from being exposed to the high-temperature gas. In this case, part of the gas received by main portion 42 enters space 20B from space 20A through the plurality of through holes 43. Thus, pressure received by plate member 41 from the gas can be reduced, thereby preventing application of an excessive load to fixation portion 45. Thus, damages of cover 21 and plate member 41 can be prevented.

Further, in the present embodiment, the plurality of through holes 43 are provided at positions not facing gas-release valves 17. With such a configuration, the high-pressure gas jetted from battery cell 11 or the shock wave caused by the spontaneous ignition can be more effectively suppressed from directly hitting cover 21.

FIG. 5 is a graph showing a change in an amount of gas in the space when the gas is generated in the battery cell. In FIG. 5, a change in an amount of gas in space 20 in the present embodiment is indicated by a solid line 310. A change in an amount of gas in space 20 in a comparative example is indicated by a dotted line 320. In the comparative example, plate member 41 is not provided with the plurality of through holes 43. An area Sa in the graph is equal to an area Sb in the graph.

The gas jetted from battery cell 11 flows from the central portion toward each of both end portions of space 20 (20A) in the X axis direction, passes through a clearance between cell stack 120 and first side portion 32, and finally reaches gas flow hole 35, with the result that space 20 is filled with the gas immediately after the generation of the gas. In this case, the internal pressure of space 20 is significantly increased, which may lead to damages of case main body 31 and cover 21 that form space 20. On the other hand, in the present embodiment, part of the gas received by main portion 42 of plate member 41 can flow from space 20A to space 20B through the plurality of through holes 43, thereby reducing the rate of filling space 20 with the gas immediately after the generation of the gas. As a result, an increased internal pressure of space 20 can be suppressed, thereby more securely preventing damages of case main body 31 and cover 21.

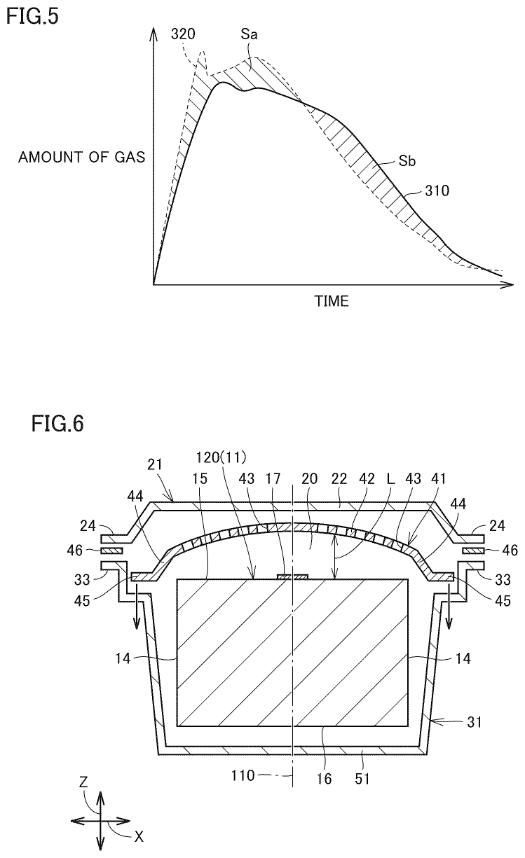

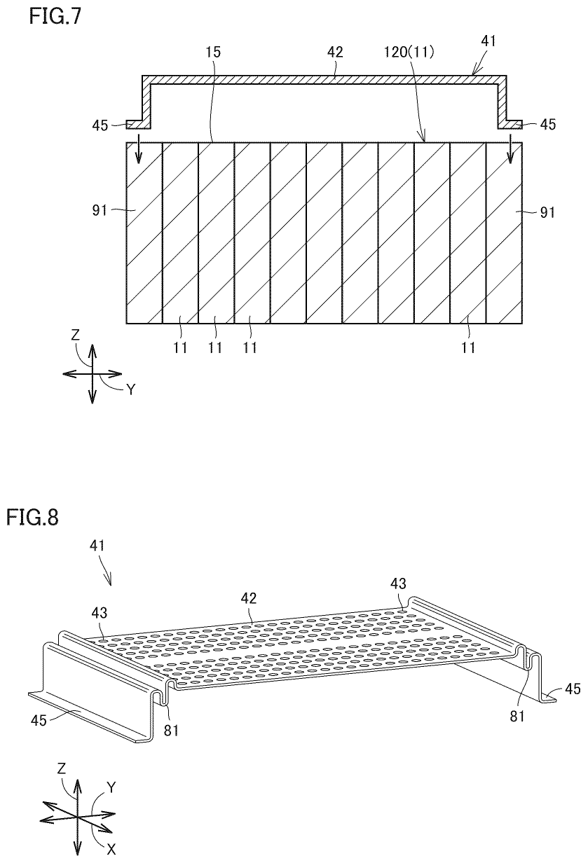

FIG. 6 is a cross sectional view showing a first modification of the battery pack in FIG. 4. FIG. 7 is a cross sectional view showing a second modification of the battery pack in FIG. 4. Referring to FIGS. 6 and 7, in each of these modifications, plate member 41 and gasket 46 are provided separately. In the modification shown in FIG. 6, fixation portion 45 is fixed to case main body 31. In the modification shown in FIG. 7, fixation portion 45 is fixed to end plate 91.

FIG. 8 is a perspective view showing a modification of the plate member in FIG. 7. Referring to FIG. 8, in the present modification, plate member 41 further has deformation portions 81. Each of deformation portions 81 is provided between main portion 42 and fixation portion 45. Deformation portions 81 are provided at both end portions of main portion 42 in the Y axis direction.

Each of deformation portions 81 is elastically deformable. Deformation portion 81 extends in the Y axis direction in the form of a wave with deformation portion 81 changing its direction between one direction and the other direction along the Z axis direction.

According to such a configuration, when the gas jetted from battery cell 11 is received by main portion 42, deformation portion 81 is elastically deformed. Thus, application of an excessive load to fixation portion 45 can be more securely prevented.

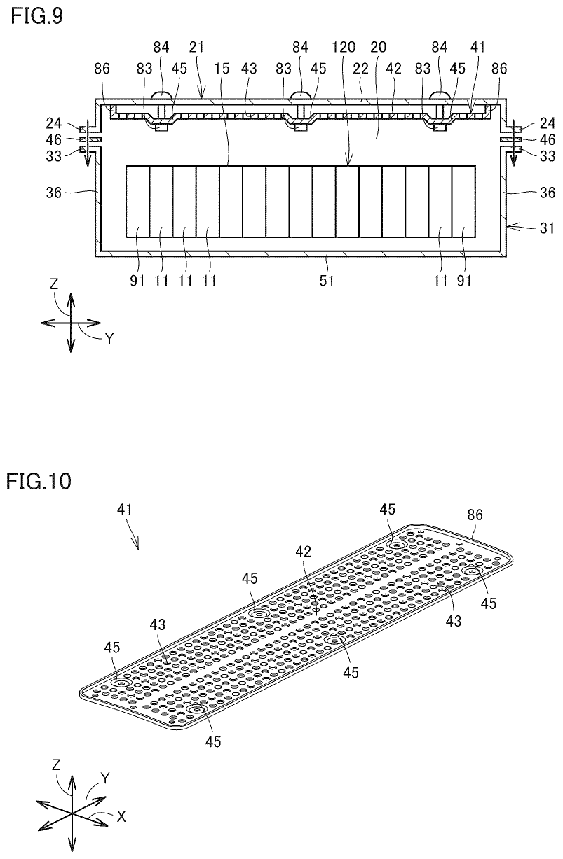

FIG. 9 is a cross sectional view showing a third modification of the battery pack in FIG. 4. FIG. 10 is a perspective view showing the plate member in FIG. 9. Referring to FIGS. 9 and 10, in the present modification, plate member 41 and gasket 46 are provided separately. Fixation portions 45 are fixed to cover 21.

Main portion 42 is provided along cover main body portion 22. Fixation portions 45 are provided in the plane of main portion 42. When main portion 42 is viewed in the Z axis direction, the plurality of fixation portions 45 are provided at intervals in each of the X axis direction and the Y axis direction. Bolts 83 are inserted into fixation portions 45. Each of bolts 83 is screwed into a nut 84 provided in cover main body portion 22.

Plate member 41 further has a peripheral edge portion 86. Peripheral edge portion 86 is formed by folding the peripheral edge of main portion 42 in a direction toward cover main body portion 22. By bringing peripheral edge portion 86 into abutment with cover main body portion 22, a space is provided between main portion 42 and cover main body portion 22.

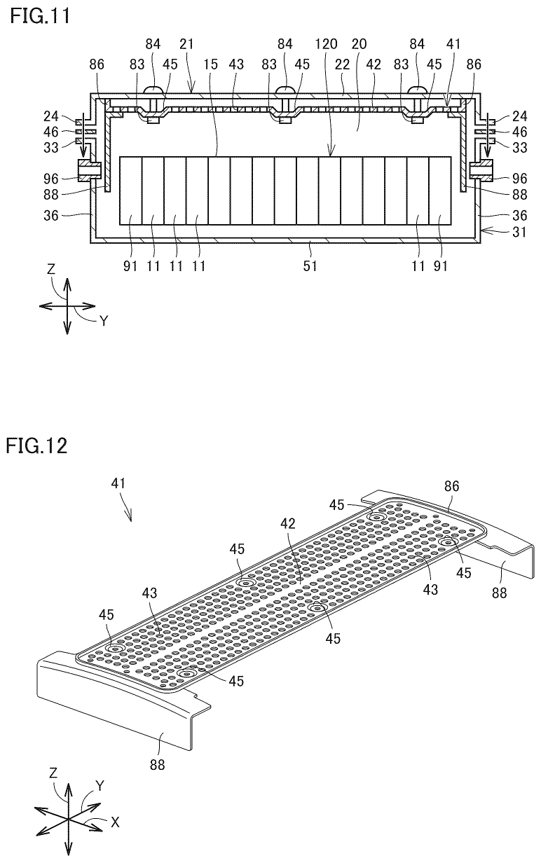

FIG. 11 is a cross sectional view showing a modification of the battery pack in FIG. 9. FIG. 12 is a perspective view showing the plate member in FIG. 11. Referring to FIGS. 11 and 12, battery pack 100 further has connectors 96. Connectors 96 are attached to case main body 31. Connectors 96 are attached to the pair of second side portions 36. Various wirings such as power lines or voltage detection lines are inserted between space 20 and the outside thereof through connectors 96.

In the present modification, plate member 41 further has shielding portions 88. Each of shielding portions 88 extends from main portion 42. Shielding portion 88 is provided to shield between connector 96 and battery cell 11.

Shielding portions 88 are provided at both end portions of main portion 42 in the Y axis direction. Each of shielding portions 88 extends from main portion 42 in the direction toward bottom portion 51 in the Z axis direction. Shielding portion 88 is disposed in a clearance between connector 96 and end plate 91 in the Y axis direction. Connector 96 faces shielding portion 88 in the Y axis direction.

According to such a configuration, by shielding portion 88, the high-temperature gas can be suppressed from flowing toward connector 96. Thus, a thermal load on connector 96 can be reduced.

It should be noted that the above-described supporting structures of various plate members 41 and the structures of each deformation portion 81 and each shielding portion 88 may be appropriately combined. For example, the structure of deformation portion 81 in FIG. 8 may be combined with plate member 41 supported in the manner shown in FIG. 6.

Summarizing the above-described configuration of battery pack 100 according to the embodiment of the present invention, battery pack 100 according to the present embodiment includes: the plurality of battery cells 11; case main body 31 provided with opening 30; and cover 21 that is attached to case main body 31 so as to close opening 30 and that forms, together with case main body 31, space 20 for accommodating the plurality of battery cells 11. Each of battery cells 11 has: exterior package 12 that includes top surface 15 facing cover 21 and that accommodates the electrode assembly and the electrolyte solution; and gas-release valve 17 that releases gas from inside of exterior package 12 to space 20 through top surface 15 when pressure in exterior package 12 becomes equal to or more than a predetermined value. Battery pack 100 further includes plate member 41 that has main portion 42 and fixation portion 45, main portion 42 being disposed between top surface 15 and cover 21 in space 20, fixation portion 45 extending from main portion 42, fixation portion 45 being fixed, main portion 42 being provided with the plurality of through holes 43, plate member 41 being composed of a metal or ceramic.

According to battery pack 100 thus configured in the embodiment of the present invention, battery pack 100 can be prevented from being damaged when gas is generated in battery cell 11.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a plurality of battery cells;
a case main body provided with an opening; and
a cover that is attached to the case main body so as to close the opening and that forms, together with the case main body, a space for accommodating the plurality of battery cells, wherein
each of the battery cells has
an exterior package that includes a top surface facing the cover and that accommodates an electrode assembly and an electrolyte solution, and
a gas-release valve that releases gas from inside of the exterior package to the space through the top surface when pressure in the exterior package becomes equal to or more than a predetermined value,
the battery pack further comprising a plate member that has a main portion and a fixation portion, the main portion being disposed between the top surface and the cover in the space, the fixation portion extending from the main portion, the fixation portion being fixed, the main portion being provided with a plurality of through holes, the plate member being composed of a metal or ceramic.

2. The battery pack according to claim 1, further comprising a duct that forms a gas flow path communicating with the space and that discharges the gas from the space.

3. The battery pack according to claim 1, wherein each of the plurality of through holes is provided at a position not facing the gas-release valve.

4. The battery pack according to claim 1, wherein the plate member further has a deformation portion provided between the main portion and the fixation portion, the deformation portion being elastically deformable.

5. The battery pack according to claim 1, further comprising a connector attached to the case main body, wherein
the plate member further has a shielding portion that extends from the main portion and that shields between the connector and each of the battery cells.
